(19) United States
(12) Patent Application Publication
(10) Pub. No.: US 2015/0015519 A1
(43) Pub. Date: Jan. 15, 2015

(54) DISPLAY AND CONTROL ELEMENT FOR A HOUSEHOLD APPLIANCE

(71) Applicant: Electrolux Home Products Corporation, Brussels (BE)

(72) Inventor: Adriano Scotto D'Apollonia, Forli (IT)

(21) Appl. No.: 14/372,347

(22) PCT Filed: Mar. 8, 2013
(86) PCT No.: PCT/EP2013/054671

§ 371 Date: Jul. 15, 2014

(30) Foreign Application Priority Data
Apr. 5, 2012 (EP) 12163372.1

(51) Int. Cl. G06F 3/041

(52) U.S. Cl. CPC G06F 3/0416
USPC 345/173

(57) ABSTRACT

A display and control element (10) for a household appliance comprising: a transparent input element (12); a display element (14) mounted behind the input element (12); and a marker element (20, 26; 30, 32) which divides the area of the input element (12) into at least one touchscreen region through which the display element (14) is visible, and at least one switching region in which the display element (14) is not visible.

The present invention relates to a display and control element for a household appliance and a household appliance provided with such a display and control element.

With modern household appliances providing for an increasing number of functions and therefore have to provide the user with the possibility to adjust various input parameters, touchscreens become more and more popular as input devices for household appliances. Since touchscreen input devices can be used to adopt a virtually unlimited number of input screens where the user can select between various choices, these devices can be used to replace an array of pushbuttons and selector switches as they are used in household appliance designs presently on the market.

The present invention aims at further facilitating the manufacturing of household appliances and in particular aims at simplifying the manufacturing and assembly of the various input devices which are used to operate the household appliances.

In accordance with the present invention this object is solved by a display and control element for a household appliance which comprises a transparent input element, a display element mounted behind the input element and a marker element which divides the area of the input element into at least one touchscreen region through which the display element is visible and at least one switching region in which the display element is not visible.

Whereas also in modern household appliances which are equipped with a touchscreen input element there usually are provided, in addition to the touchscreen input element, a plurality of selector switches, such as pushbuttons, in accordance with the present invention the number of components to be assembled is further reduced by employing a transparent input element both as input device for the touchscreen input region and as input device for a switching region which can comprise one or a plurality of switching elements. Thus, rather than having to provide and assemble a transparent input element and a display element for the touchscreen region and additionally a plurality of pushbuttons for the switching region, which components all have to be connected to respective terminals of a control unit which operates the various components of the household appliance, in accordance with the present invention, instead of providing for a transparent input element the entire area of which is used in conjunction with the display element, in accordance with the present invention only a portion of the transparent input device is used as a variable input element for any parameter or option indicated at the display element, whereas another portion of the transparent input element is used as a dedicated selector element which thus permanently provides for an input region for a certain function or parameter, similarly as is the case for conventional pushbuttons.

Preferred embodiments of the present invention are defined in the dependent claims.

While thus generally the discrimination between the at least one touchscreen region and the at least one switching region can be made by providing markings on either side of the transparent input element, in a first embodiment of the present invention the marker element comprises a blind, which is located at the rear side of the input element and which covers the switching region.

In dependency of the relative sizes of the transparent input element, on the one hand, and of the display element, on the other hand, the blind or a portion thereof can overlay a portion of the display element so as to cover a certain area of the display element, or it can be located outside the perimeter of the display element.

In a first preferred embodiment a transparent input element is employed, which covers a larger area than the display element so as to provide, in addition to the touchscreen region which overlays the display element, for an additional region of the transparent input element, wherein in the region that does not overlay the display element and which is employed as switching region there is located a blind which may be provided with markings that indicate the purpose of the respective switching region. Thus, the design of the blind can be selected to simulate a conventional switching array comprising pushbuttons which are designated by respective symbols or labels.

In order to improve the visibility and legibility of any symbols or labels that are provided in the switching region, the blind, in the portion covering the switching region, can comprise a translucent marking that is illuminated by a light source provided in the display and control element.

Alternatively or additionally to providing a blind that is located at the rear side of the input element, the marker element further can comprise a cover which is located at the front side of the input element, wherein the cover is made of a substantially opaque material and comprises a first see-through area for the touchscreen region and a second see-through area for the switching region. Providing for a cover which is located on the front side of the input element allows for better discriminating between the touchscreen region and the switching region because the cover thus divides the continuous surface of the transparent input element into an area covering the touchscreen region and an area covering the switching region. The discrimination between these regions can be further improved by providing for surface characteristics and/or a geometry of the cover which clearly differs from that of the transparent input element, such as by providing for a transparent input element having a smooth glossy surface and providing for a cover element having a matte finished rough surface. In this manner there can be provided both for an optic and a haptic discrimination between the touchscreen region and the switching region.

While both the blind and/or the cover can comprise an opaque layer which is applied to the transparent input element, such as by providing for a blind or cover comprising a layer that is printed onto the transparent input element or comprises an adhesive foil element adhering to the transparent input element, in alternative embodiments the cover can comprise a plate having apertures which constitute the see-trough areas. In such embodiments the cover thus can form frame portions about the touchscreen region and the switching region(s).

In preferred embodiments the transparent input element comprises a capacitive foil, for example a foil which is made of indium tin oxide (ITO). While such capacitive foils are readily available as they are used in many of presently available touchscreen devices, such as smart phones and the like, the transparent input element also could be made of other types of transparent input elements, such as patterned conductive polyester films.

A preferred field of use of the display and control element of the present invention is in a household appliance, such as a range, a stove, a cooktop, an oven, a hearth, a microwave oven, a warmer drawer, a dishwasher, a washing machine, a dryer, a drying cabinet, a wine cabinet, a wine cooler, a refrigerator, a freezer, a food processor, a water heater, a trash compactor or a ventilation hood.

Preferred embodiments of the present invention are described in further detail below by reference to the drawings in which:

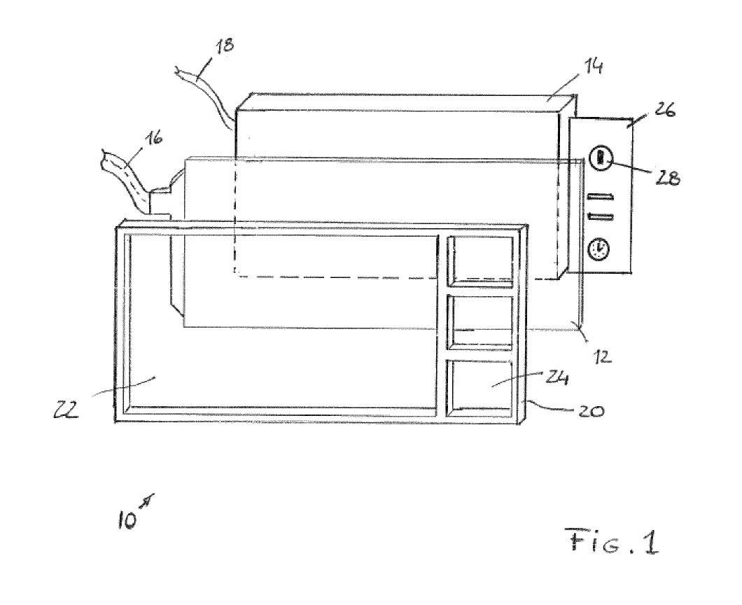

FIG. 1 illustrates a first embodiment of a display and control element made in accordance with the present invention; and

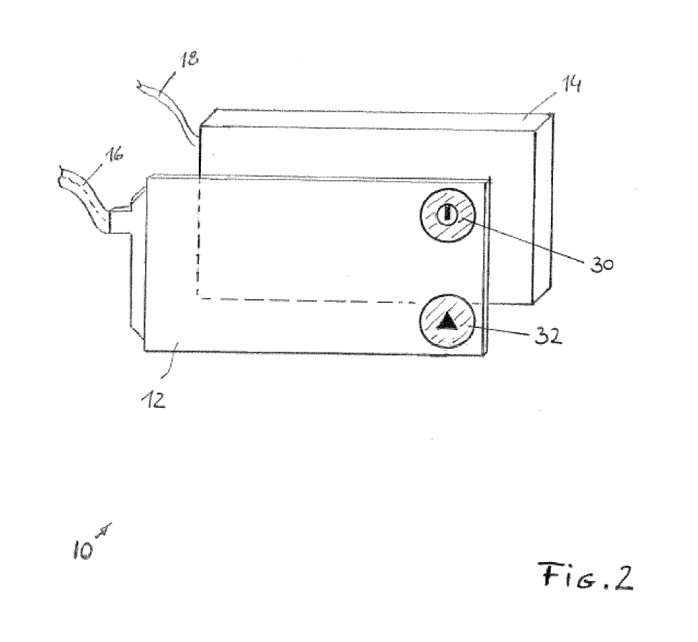

FIG. 2 illustrates an alternate embodiment of the display and control element shown in FIG. 1.

In FIG. 1 there is shown a first embodiment of a display and control element for a household appliance made in accordance with the present invention. The display and control element 10 comprises a transparent input element 12 which may comprise a capacitive foil of patterned indium tin oxide (ITO) which is applied onto a polyethylene terephthalate (PET) layer. Behind the transparent input element 12, there is provided a display element 14, such as a liquid crystal display (LCD) and preferably a thin-film transistor display (TFT). Both, the transparent input element 12 and the display 14 are connected via respective connecting cables 16 and 18, respectively, to a control unit (not shown) of the household appliance.

In the embodiment shown in FIG. 1, the transparent input element 12 is of larger size than the display element 14 so as to provide for an area of the input element 12 which in FIG. 1 projects to the right beyond display element 14 to provide, in addition to a touchscreen input region, for an additional switching input region. Thus, in order to divide the area of the input element into a touchscreen region that coincides with or overlays the display element 14 and an additional switching region which is located in the area of the input element which does not overlay the display element 14, there is provided a cover 20 which is mounted in front of the transparent display element 12.

In the embodiment illustrated in FIG. 1, cover 20 is made of a sheet material, such as a glass plate having a serigraphy layer, or comprises a frame that is formed of plastics. Cover 20 comprises a larger first aperture 22 the shape and size of which substantially corresponds to the display 14, as well as three smaller apertures 24 which are located to the right of aperture 22. While the first aperture 22 thus acts as a first see-trough area to display 14, the smaller apertures 24 act as second see-trough areas to a blind 26 which is provided at the rear side of the transparent input element aside display 14. In this manner the area of the transparent input element 12 is divided into a touchscreen region that is delimited by aperture 22 as well as three switching regions that are delimited by the smaller apertures 24.

While by displaying variable messages and input parameters at display 14, the touchscreen region of input element 12 provides for a variable input region, the additional area of the input element provided in the switching regions that are delimited by apertures 24 can be used for dedicated switching functions. In the embodiment shown in FIG. 1 the switching regions of the transparent input element 12 which are provided in apertures 24 act as three push buttons which can be operated to trigger certain dedicated functions.

In order to provide the user with guidance of the specific function of the respective switching region, blind 26 which is provided at the rear side of the transparent input element and which may be a sticker that adheres to the rear side of the transparent input element, can be provided with symbols 28 which indicate the function of the respective switching region that is delimited by each of the apertures 24 of cover element 20.

In FIG. 2 there is shown a further embodiment of a display and control element. Here, the transparent input element 12 is of similar size as the display 14. In order to divide the area of the input element into a touchscreen region that overlays the display element and through which the display element is visible, and an additional switching region providing permanently for a dedicated function and in which the display element is not visible, there are provided two blinds 30 and 32 at the rear side of transparent input element 12, which similarly as blind 26 of the embodiment shown in FIG. 1 may comprise foil elements that adhere to the rear side of input element 12. Blinds 30 and 32 are provided with symbols which indicate to the user the function of the respective switching region.

The visibility of the symbols in the switching region can be further improved by providing for backlight illumination. In the embodiment shown in FIG. 1 this can be implemented by forming blind 26 of an opaque material having translucent markings 28 which are illuminated by a light source that is located behind blind 26. In the embodiment shown in FIG. 2, a backlight function for blinds 30 and 32 can be provided by the display 14 itself which can be controlled to illuminate the markings of blinds 30 and 32.

1. Display and control element (10) for a household appliance comprising:
a transparent input element (12);
a display element (14) mounted behind the input element (12); and
a marker element (20, 26; 30, 32) which divides the area of the input element (12) into at least one touchscreen region through which the display element (14) is visible, and at least one switching region in which the display element (14) is not visible.

2. The display and control element (10) of claim 1, wherein the marker element comprises a blind (26; 30, 32) located at the rear side of the input element (12) which covers the switching region.

3. The display and control element (10) of claim 2, wherein the blind (26; 30, 32) in the portion covering the switching region comprises a translucent marking (28), the display and control element (10) further comprising a light source for illuminating the marking.

4. The display and control element (10) of claim 1, wherein the marker element comprises a cover (20) located at the front side of the input element (12), wherein the cover (20) is made of a substantially opaque material and comprises a first see-through area (22) for the touchscreen region and a second see-through area (24) for the switching region.

5. The display and control element (10) of claim 1, wherein the blind (26; 30, 32) and/or the cover (20) comprises an opaque layer applied to the transparent input element (12).

6. The display and control element (10) of claim 5, wherein the blind (26; 30, 32) and/or the cover (20) comprises a printed layer or an adhesive foil element.

7. The display and control element (10) of claim 4, wherein the cover (20) comprises a plate having apertures (22, 24) which provide for the see-through areas.

8. The display and control element (10) of claim 1, wherein the transparent input element (12) comprises a capacitive foil.

9. The display and control element (10) of claim 8, wherein the capacitive foil is made of indium tin oxide (ITO).

10. The display and control element (10) of claim 1, wherein the transparent input element (12) comprises a patterned conductive polyester film.

11. Household appliance with a display and control element (10) as defined in claim 1.

12. The household appliance of claim 11, comprising an at least partially front panel, wherein the input element (12) is laminated onto the front panel.

13. The household appliance of claim 11, which is a range, a stove, a cooktop, an oven, a hearth, a microwave oven, a warmer drawer, a dishwasher, a washing machine, a dryer, a drying cabinet, a wine cabinet, a wine cooler, a refrigerator, a freezer, a food processor, a water heater, a trash compactor or a ventilation hood.
